(19) United States
(12) Patent Application Publication
(10) Pub. No.: US 2018/0194287 A1
(43) Pub. Date: Jul. 12, 2018

(54) MIRROR DEVICE

(71) Applicant: FORD GLOBAL TECHNOLOGIES, LLC, Dearborn, MI (US)

(72) Inventors: Christoph Arndt, Moerlen (DE); Frederic Stefan, Aachen (DE); Uwe Gussen, Huertgenwald (DE); Frank Petri, Erftstadt (DE)

(21) Appl. No.: 15/854,089

(22) Filed: Dec. 26, 2017

(30) Foreign Application Priority Data
Jan. 11, 2017 (DE) 102017200381.2

(51) Int. Cl. B60R 1/02; B60R 1/08; B60R 1/072

(52) U.S. Cl. CPC B60R 1/025; B60R 1/081; B32B 17/06; B32B 2307/51; B60R 1/072

(57) ABSTRACT

A mirror device includes at least one planar mirror arrangement which is constructed as a mirror element. The mirror element is resiliently bendable at least about axes parallel or tangential to a mirror element surface or is reversibly foldable about at least one fold line in the mirror element surface. The mirror element is coupled to at least one actuator, which is designed and constructed to effect a resilient bending or a reversible folding of the mirror element upon actuation.

### TECHNICAL FIELD

This document relates to a mirror device, in particular a rearview mirror for a vehicle.

### BACKGROUND

Vehicles are normally equipped with rearview mirrors to enable the driver to monitor the surroundings behind him. Such monitoring of the rearward area is vital for safety reasons.

To this end, mirror devices of a conventional design are known, which enable the driver to monitor the rearward surroundings of the vehicle in standard driving situations, for example driving straight ahead on a country road or freeway. To improve the monitoring of the environment around a vehicle in particular driving situations, it is known to pivot a mirror glass for example of the right exterior mirror downwards as a whole during curb-side parking, to thereby enable better monitoring of a curb edge or surroundings directly adjacent to the vehicle.

To expand the field of view with a predetermined mirror-surface size, it is furthermore known to construct the mirror surface such that it is aspherically curved, for example, to enable a larger surrounding region to be monitored in the manner of a spherical mirror with a predetermined mirror-surface size.

A disadvantage with this is that the objects which are visible in the mirror appear smaller or appear farther away than they actually are.

It is furthermore known for example from EP 04 06 638 A1 to provide an adapted mirror device for unusual driving situations. In this, it is proposed for example to place an additional, convexly curved mirror on the exterior mirror housing when towing a trailer. The option is moreover proposed for a further mirror to extend from the exterior mirror housing, away from the vehicle body, to adapt the rearward field of view to the length of the vehicle/trailer combination, which is greater than that of the length of the towing vehicle. A mirror device of this type is disadvantageous in that the vehicle width is increased, thereby hampering maneuvering movements in tight road surroundings, e.g. in narrow streets.

Furthermore, a high degree of mechanical complexity is required to accommodate a second extendable mirror in a mirror housing.

U.S. Pat. No. 7,216,993 B2 discloses an exterior mirror which has a main mirror surface. In addition to the main mirror surface, an auxiliary mirror is arranged in the housing, which auxiliary mirror is designed to be folded out manually or by means of a motor.

It is furthermore proposed to arrange an auxiliary mirror in a single piece and at an angle to the main mirror surface in order to increase the field of view. This embodiment is disadvantageous in that a high degree of mechanical complexity is required to construct a fold-out auxiliary mirror. Furthermore, a rigid attachment of the auxiliary mirror may result in an undesired outer contour of the exterior mirror housing.

### SUMMARY

An object of the new and improved mirror device disclosed herein is to provide a mirror device which can be adapted to particular driving situations in a simple manner, in particular in an automated manner, and is able to present an adapted mirror image corresponding to these driving situations.

It is furthermore an object to satisfy the above-mentioned requirements without the provision of auxiliary mirrors in addition to a mirror which is already necessary for normal operation.

In particular, it is an object to provide a mirror device which enables a high degree of freedom in terms of construction and design, and in particular satisfies the high design requirements for example in automotive engineering, e.g. in automobile engineering.

The above-mentioned objects are achieved by a mirror device having the features of the following description and claims.

The above-mentioned objects are achieved by a mirror device, in particular a rearview mirror for a vehicle, which has at least one planar mirror arrangement. That planar mirror arrangement is constructed as a mirror element and is resiliently bendable at least about axes parallel or tangential to a mirror element surface or is reversibly foldable about at least one fold line in the mirror element surface, wherein the mirror element is coupled to at least one actuator. The at least one actuator is designed and constructed to effect a resilient bending or a reversible folding of the mirror element upon its actuation.

Foldable glass can be used to enable the reversible folding of the mirror element surface. Alternatively, the mirror device can have at least one planar mirror arrangement which has at least one first rigid mirror element and at least one second rigid mirror element, wherein the mirror elements are displaceable such that they can pivot with respect to one another about a pivot axis and at least one mirror element is coupled to at least one actuator which is designed and constructed to displace the at least one mirror element such that it pivots relative to the other mirror elements about the pivot axis.

In a preferred embodiment of this variant of the mirror device, the rigid mirror elements in a starting position are arranged such that they collectively form a common kink-free mirror surface. Such a common kink-free mirror surface can therefore be regarded for example as a normal position or starting position of the mirror device. In an advantageous manner, it is furthermore possible to arrange the rigid mirror elements displaceably such that they can pivot with respect to one another about a common outer edge. This results in a gap-free or virtually gap-free common kink-free mirror surface in a starting position so that the mirror image in the starting position is only slightly disrupted. At the same time, it is advantageous that, with an arrangement of this type, the joint has wider gaps when one of the rigid mirror elements is arranged such that it is bent relative to the other.

In this regard, the driver is already informed via the joint that one of the mirror elements is arranged bent with respect to the central mirror element and an expansion of the field of view is occurring, which deviates from a starting position. In an advantageous manner, it can furthermore be provided for the rigid mirror elements in the starting position to abut against one another at the edges without gaps and/or to form an overall mirror surface which is kink free and/or has a constant curvature. In an embodiment of this type, the mirror image is only slightly disrupted by the mirror elements abutting closely against one another in a gap-free or virtually gap-free manner.

The planar mirror arrangement here can be constructed in particular in a single piece as a mirror element if it is resiliently bendable or if foldable glass is used.

The mirror device is based on the idea that a planar mirror arrangement is constructed such that it can be altered in terms of its spatial form, using either a resilient deformability or a reversible foldability of the mirror arrangement. By means of the mirror device, a single planar mirror arrangement can be advantageously altered in terms of its spatial form in such a way that an expansion of the field of view or a change in the field of view is possible through deformation of a resilient mirror element or through reversible folding of a mirror element. Common to both variants is that the mirror device can be accommodated in a housing and, in normal operation, for example in a starting position, a single mirror surface is present which can be adapted to corresponding driving situations.

In an advantageous embodiment of the mirror device, the mirror element has a resiliently bendable support, which can be formed for example from a plastic material, a glass or from a metal.

In particular, when the support is made from glass, it is for example possible to construct this very thinly so that it is resiliently deformable or foldable without splitting.

In a further advantageous embodiment of the mirror device, the mirror arrangement has at least one actuator which is constructed for example as an actuator matrix comprising a plurality of actuators, wherein the individual actuators or actuator groups can be actuated separately or independently.

With this embodiment, sub-regions of the resiliently bendable mirror element can be bent or folded with respect to a residual region and therefore have a different spatial orientation so that it is possible to influence the field of view which is visible by means of the mirror device.

A multiplicity of actuators, combined to form an actuator matrix, affords the option of realizing a wide range of changes in terms of the spatial form of a resilient mirror element depending on the activation of the individual actuators of this actuator matrix.

In a particular embodiment of the mirror device, at least one sub-region of the resilient mirror element is resiliently bendable or reversibly foldable relative to a residual region of the mirror element in order to displace said sub-region.

It is thus possible, for example, in a simple manner, to arrange a sub-region of the mirror element relative to the residual region in such a way that an expansion of the field of view or a change in the field of view can be realized, wherein the residual region of the mirror element can remain in the starting position and the original field of view is therefore still visible, at least in part.

In an advantageous manner, the entire resilient mirror element can furthermore be pivotable about at least one spatial axis and/or foldable along at least one spatial axis relative to a user such that it is free of bending and folding deformations. With an arrangement of this type, it is for example possible to effect a basic adjustment of the mirror relative to the position of the user.

The resiliently bendable or reversibly foldable mirror element can furthermore be deformable depending on a current driving/traffic situation. For example, if a control of the mirror device perceives that an acute-angled approach to a highway lies ahead, it can be expedient here for part of the left exterior mirror to bend away further outwards so that the driver is better able to see the lane he is intending to join.

The mirror device can expediently be used as a rearview mirror of a motor vehicle, in particular as an exterior mirror of the motor vehicle.

### BRIEF DESCRIPTION OF THE DRAWING FIGURES

The mirror device is explained in more detail below by way of example with reference to the drawing, which shows:

FIG. 1: a schematic view of a first embodiment of the mirror device designed as a vehicle exterior mirror, looking forward in the longitudinal direction of the vehicle;

FIG. 2: a schematic section along the line A-A of FIG. 1 in a first operating position;

FIG. 3: a schematic section along the line B-B of FIG. 1 in a second operating position;

FIG. 4: a schematic section along the line A-A of FIG. 1 in a third operating position;

FIG. 5: a schematic section along the line B-B of FIG. 1 in the third operating position of the mirror device;

FIG. 6: a schematic view of a second embodiment of the mirror device designed as a vehicle exterior mirror, looking forward in the longitudinal direction of the vehicle (second embodiment);

FIG. 7: a section along the line A-A of FIG. 6 (first operating position);

FIG. 8: a section along the line B-B of FIG. 6 (second operating position);

FIG. 9: a schematic view of a driving situation in which advantages of the mirror device can be used;

FIG. 10: a further driving situation in which the advantages of the mirror device can be used;

FIG. 11: a schematic view of a further driving situation (reversing with obstacles) in which the advantages of the mirror device can be used.

### DETAILED DESCRIPTION

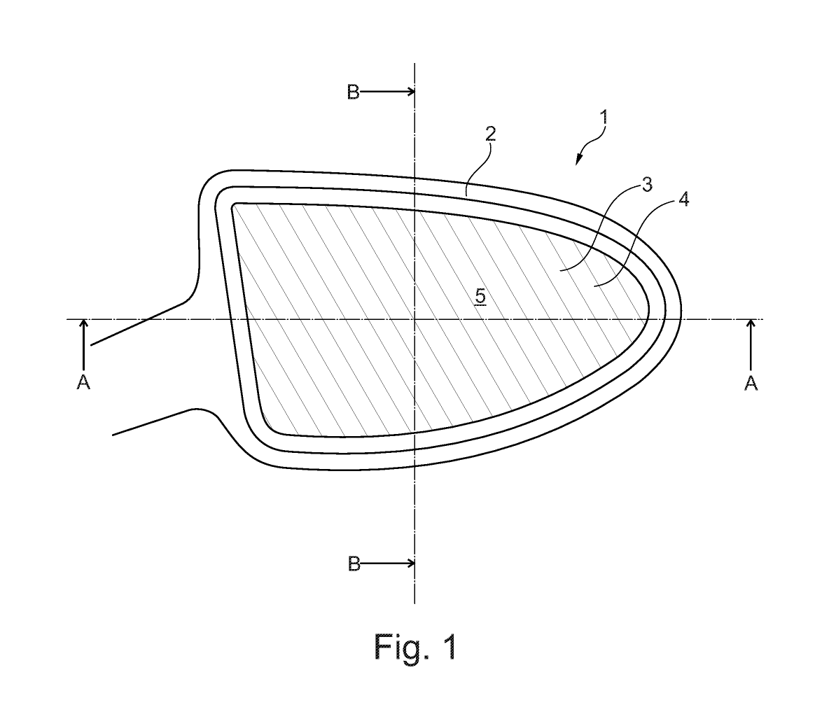

With reference to FIGS. 1 to 5, a first embodiment of the mirror device 1 is explained below by way of example. Such a mirror device 1 is constructed for example as an exterior mirror of a vehicle and has a housing 2 in which a planar mirror arrangement 3 is provided. The planar mirror arrangement 3 is constructed undivided and in a single piece as a mirror element 4, which is resiliently bendable at least about axes parallel or tangential to a mirror element surface 5.

In an illustration according to FIG. 1, such axes are for example axes which are located in the plane of the drawing of FIG. 1 or are arranged parallel thereto. To realize a basic adjustment of the mirror arrangement 3, the mirror element 4 can be mounted in the housing 2 such that it is pivotably displaceable as a whole in a known manner, wherein, to pivot the mirror arrangement 3, a manual operating device can be provided or a motorized drive device is present.

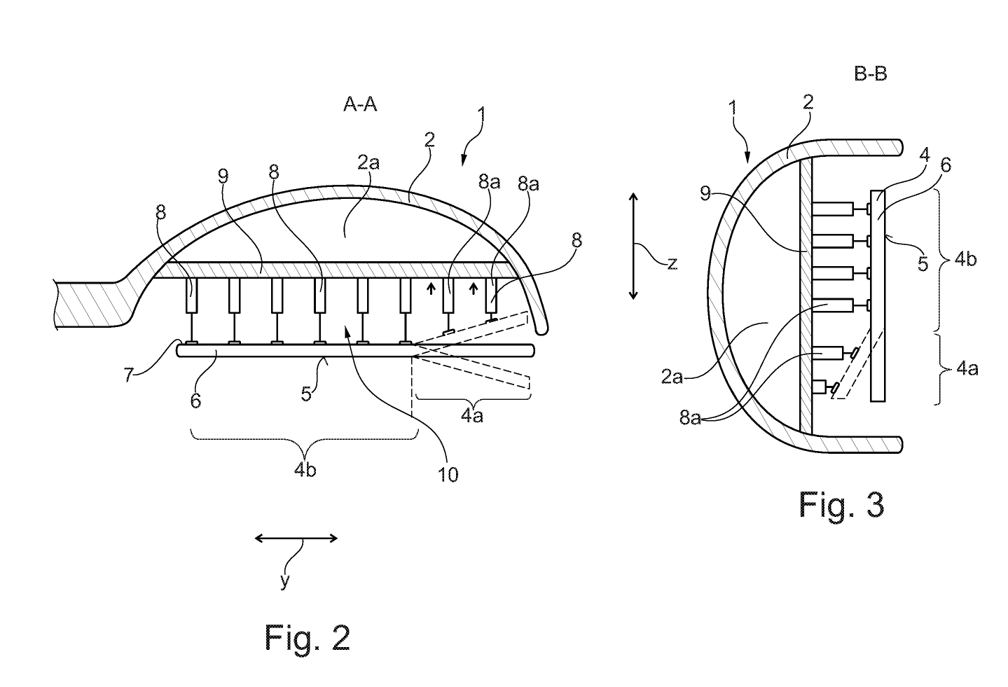

The mirror element surface 5 is that surface at which the user of the mirror device 1 glances to observe a mirror image. As shown in FIGS. 2 and 3, the mirror element 4 has for example a support 6 which has a corresponding mirror coating on the reverse side 7 opposite the mirror element surface. This is in particular in the form of a light-reflective coating. To this end, the support 6 is of a transparent construction. According to a first variant of the mirror device 1, the reverse side 7 of the support 6 is coupled to a plurality of actuators 8. The actuators 8 are constructed for example as linear actuators and are coupled to a support plate 9 at one end. At their other end, the actuators, distributed over the reverse side 7, are connected to the mirror element 4. The multiplicity of actuators form an actuator matrix 10, wherein the individual actuators 8 or selected groups of actuators 8 of the actuator matrix 10 can be activated independently of other actuators 8. Distributed over the reverse side 7, the actuators 8 of the actuator matrix can be arranged for example in a plurality of rows and/or columns or on concentric lines, e.g. circles or ellipses.

A sectional illustration according to FIG. 2 shows the schematic section along the line A-A of FIG. 1.

In a starting position (continuous line) of the mirror element 4, the mirror element is in a planar state wherein, in such a planar state, the mirror image is presented to the user in an undistorted manner.

Depending on a particular driving situation, it can be expedient, for example, to increase the field of view of the region covered by the mirror element 4. To this end, it is expediently possible for some of the actuators, in this case the actuators 8a, to be activated so that a sub-region 4a of the mirror element is displaced such that it is bent with respect to a residual region 4b.

In the example according to FIG. 2, a displacement of the sub-region 4a towards an interior 2a of the housing can result in an expansion of the field of view to a more remote side region of the vehicle being effected. If, from its starting position, the sub-region 4a is displaced slightly outwards from the housing by means of the actuators 8a, this results in an expansion of the view to the extent that situations arising close to the vehicle, for example, are perceived more easily. Such a position of the sub-region 4a is illustrated schematically in FIG. 2 by a dotted line.

FIG. 3 shows a further application of the mirror device 1 in a sectional illustration along the line B-B in FIG. 1. In the case illustrated, actuators 8a, which are coupled in a lower region 4a of the mirror element 4 as seen in the vertical direction Z of the vehicle, are activated. The residual region 4b of the mirror element 4 remains in its e.g. planar starting state. By means of the actuators 8a (FIG. 3), a lower region of the mirror element 4 as seen in the vertical direction of the vehicle (Z-direction) is displaceable with respect to the residual region 4b in the direction of the housing interior 2a so that an expansion of the field of view is produced to the extent that, when the user glances at the sub-region 4a of the mirror element 4, it is possible to obtain an overview of the field of view which relates more strongly to the floor of the vehicle than the residual region 4b. Such a resilient deformation of the mirror element 4, as is illustrated in FIG. 3, makes sense for example in a parking situation, in particular in a curb-side parking situation, in which it is important for the driver of the vehicle, for example, to be able to perceive a curb or other obstacles located near to the vehicle, in the vicinity of the floor. Since only part of the mirror element 4, namely the sub-region 4a, is used to expand the field of view, the residual region 4b can remain in its starting position and continue to afford the user at least a predominant part of the field of view of the mirror element 4 in its starting position.

The design of the mirror element 4 with a resiliently bendable support 6 is particularly advantageous in that a uniform, uninterrupted mirror element surface 5 is present in a starting position and the user of the mirror device 1 is therefore provided with an undisrupted mirror image. In particular driving situations, it is possible to achieve an expansion of the field of view through an at least regional bending of sub-regions 4a, without additional mirror elements being necessary or an overall displacement of the mirror element 4 having to be effected. An inevitable disadvantageous consequence of such an overall displacement of the mirror element 4 as is already known from the prior art is that a residual region 4b remaining in the starting position is no longer present and therefore at least a large part of the field of view in the starting position is missing.

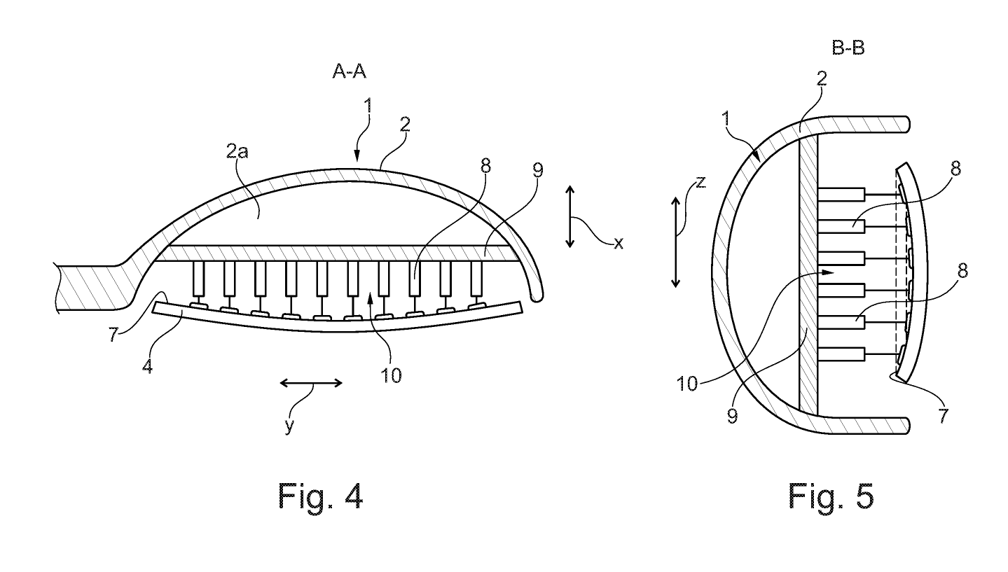

According to a further embodiment of the mirror device 1 (cf. FIGS. 4 and 5), the mirror element 4 can, if required, be deformed in a convexly curved manner both in the vertical direction of the vehicle (cf. FIG. 5) and in the transverse direction Y of the vehicle (cf. FIG. 4) in that the actuators 8 or the actuator matrix 10 is/are activated such that the mirror element 4 experiences an arching in at least one of the above-mentioned directions or preferably in both directions. Such an arching can be produced from a planar mirror element 4 in the starting position through resilient bending so that, if required, a mirror element 4 can be produced which has a spherical or aspherical curvature. The field of view of a mirror element 4 which is spherically or aspherically curved in this way is therefore greatly expanded compared to its planar starting position. It is thus easily possible to simulate or produce a spherical or aspherical exterior mirror. In this application, the entire surface of the mirror element 4 is preferably used for the bendable deformation.

In FIGS. 2 to 5, the support plate 9 is illustrated as unmovable with respect to the housing 2. It goes without saying that—as already mentioned above—it can be useful to realize an adjustability of the mirror device 1 in terms of its basic adjustment—be it by means of a motor or manually—through a displacement of the support plate 9, for example by pivoting the support plate 9 about the spatial axes X, Y, Z. Instead of a displacement of the support plate 9 with respect to the housing 2, it can also be optionally expedient to achieve the basic adjustment of the mirror device 1 through a pivotal displacement of the housing 2 about the spatial axes X, Y and Z.

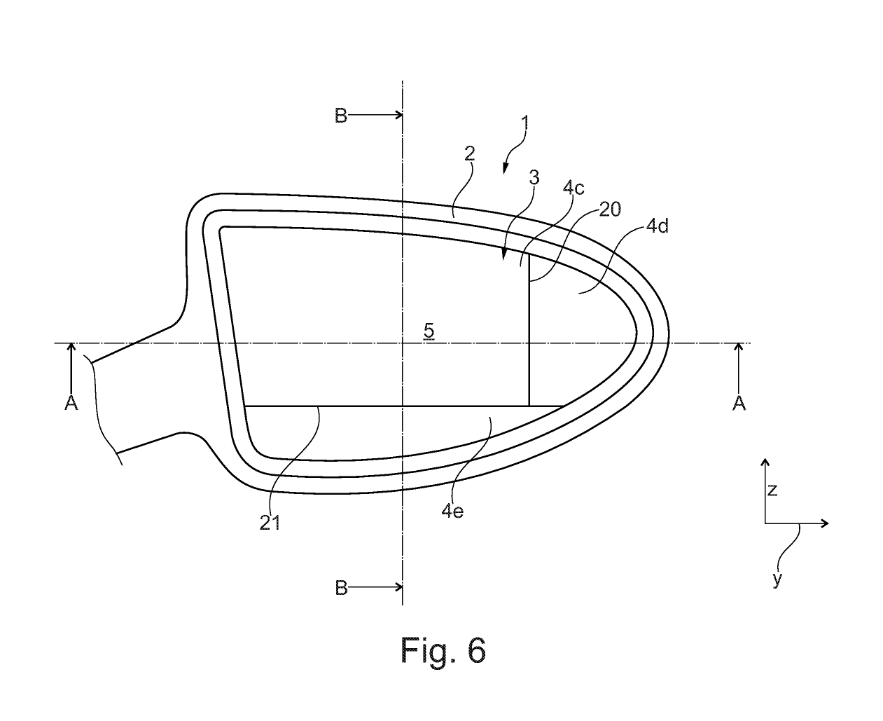

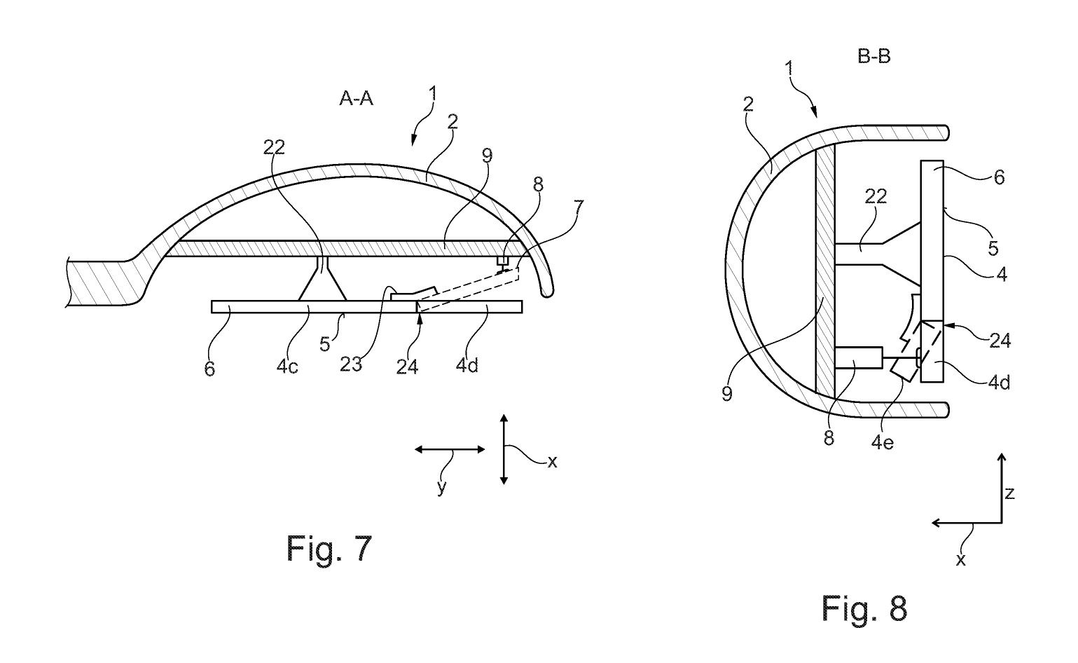

In contrast to the first variant of the mirror device 1 shown in FIGS. 1-5, a mirror device 1 according to a second embodiment has a mirror arrangement 3 which has a plurality of mirror elements 4c, 4d, 4e (see FIGS. 6-8). The mirror elements 4c, 4d, and 4e are constructed as rigid mirror elements and are mounted such that they are pivotable about pivot axes 20, 21 with respect to one another so that a folding of the mirror elements relative to one another is possible. By way of example, in the embodiment according to FIG. 6, the mirror element 4d (first secondary mirror element) is mounted such that it is pivotable about the pivot axis 20 relative to the mirror element 4c (main mirror element). The mirror element 4e (second secondary mirror element) is furthermore mounted such that it is pivotable about the pivot axis 21 relative to the mirror element 4c (main mirror element). The main mirror element (cf. FIGS. 7 and 8) 4c is rigidly mounted on the support plate 9 for example by means of a bearing 22.

By way of example, the mirror element 4d is connected to the mirror element 4c by means of a film hinge 23. The mirror element 4d is coupled on its reverse side 7 to an actuator 8 with which the mirror element 4d can be moved from its starting position (continuous line) into its angled position (dashed line in FIG. 7). Through such a pivoting of the mirror element 4d, a gap 24 which is wider than in the starting position is produced between the mirror elements 4c and 4d. Such a widening of the gap 24, which, in the starting position according to FIG. 6, can be formed as small as possible or even as zero gap, indicates to the user that the mirror, in particular the mirror element 4d, is in a deflected position. By way of example, in the illustration according to FIG. 7, the field of view to the side of the vehicle can be expanded through a pivoting of the mirror element 4d, so that it is possible for the user to monitor a region which is located further away from the vehicle to the side, i.e. in the transverse direction of the vehicle.

Instead of folding two mirror elements relative to one another, it is also possible for portions of a single-piece mirror to be folded if the glass used enables a folding of the glass.

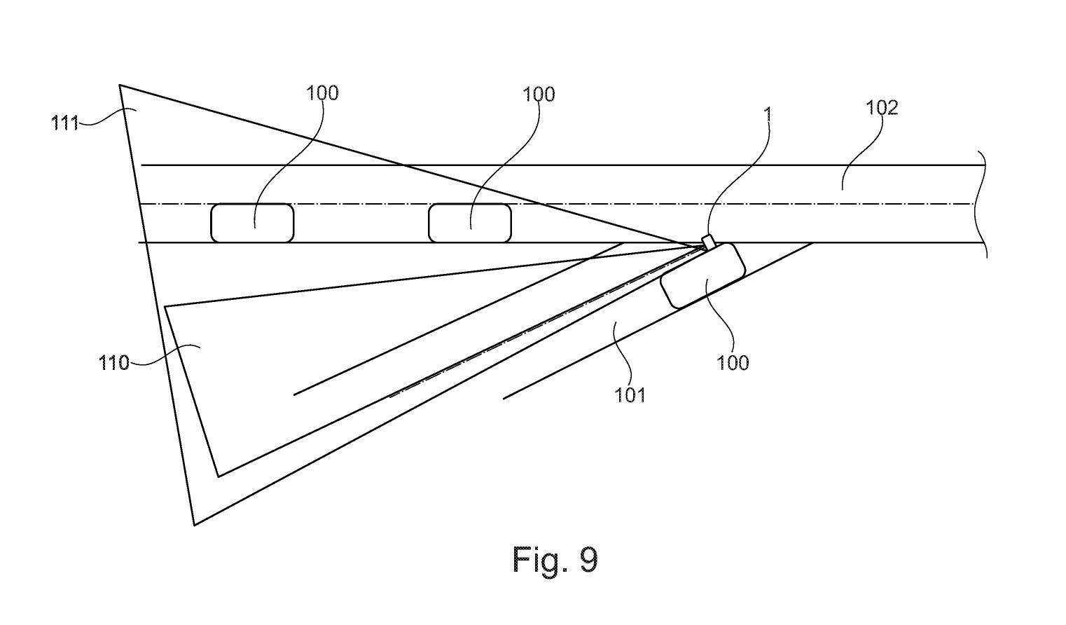

Different driving situations in which a mirror device 1 can be expediently used are demonstrated below with reference to FIGS. 9 to 12.

FIG. 9 shows an acute-angled merging situation of a motor vehicle 100 which is located on an approach 101 to a main road 102. The motor vehicle 100 is equipped with a mirror device 1, in the present case as a left exterior mirror. Such driving situations, e.g. an acute-angled entry or the like, can already be perceived for example before they are reached, e.g. with the assistance of a vehicle surround sensor. With the aid of a navigation system and/or a vehicle camera which can monitor the vehicle surroundings, e.g. the angle of the converging roads and/or an angle of a driving path of the vehicle relative to the road(s).

With this information, the field of view 110 can be automatically and optionally preliminarily adapted in an optimal manner. In its starting position, the mirror device 1 provides a field of view 110. It is clear that the field of view 110 does not enable the driver of the vehicle 100 to monitor further motor vehicles 100 approaching the merging point on the main road 102, or only does so inadequately. In such a traffic situation, it can be expedient to expand the field of view of the mirror device 1, which can be realized for example by curving a bendable mirror element 4 or by displacing pivotable mirror elements 4d relative to the main mirror element 4c. Such an arrangement can provide an expanded field of view 111, which also easily captures the approaching motor vehicles 100 on the main road 102 and renders them perceptible to the user of the mirror device 1.

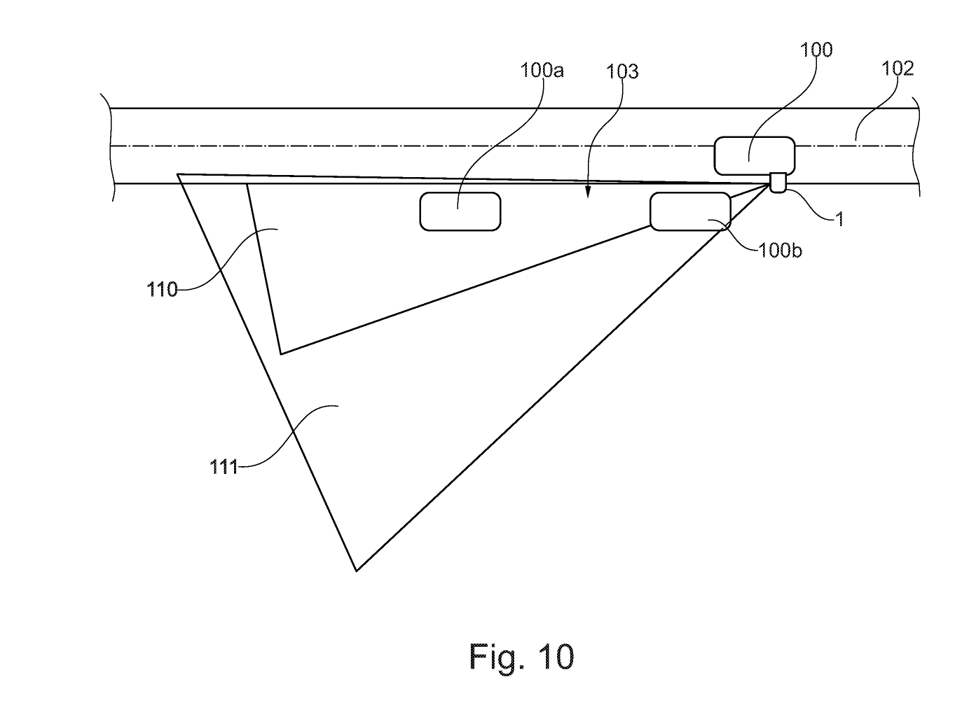

A further driving situation in which the mirror device 1 can advantageously be used is shown in FIG. 10. The motor vehicle 100 is located on a main road 102. Next to the road 102, on the right, there is a parking space 103 into which the driver of the motor vehicle 100 wishes to reverse lengthwise.

A mirror device 1 in its starting position provides the field of view 110, which—as illustrated in FIG. 10—fully captures a motor vehicle 100a to the rear, but not a vehicle 100b to the front. Suitable actuation of the mirror device 1 produces the expanded field of view 111 which also renders the front vehicle 100b readily visible to the user of the motor vehicle 100 equipped with the mirror device 1.

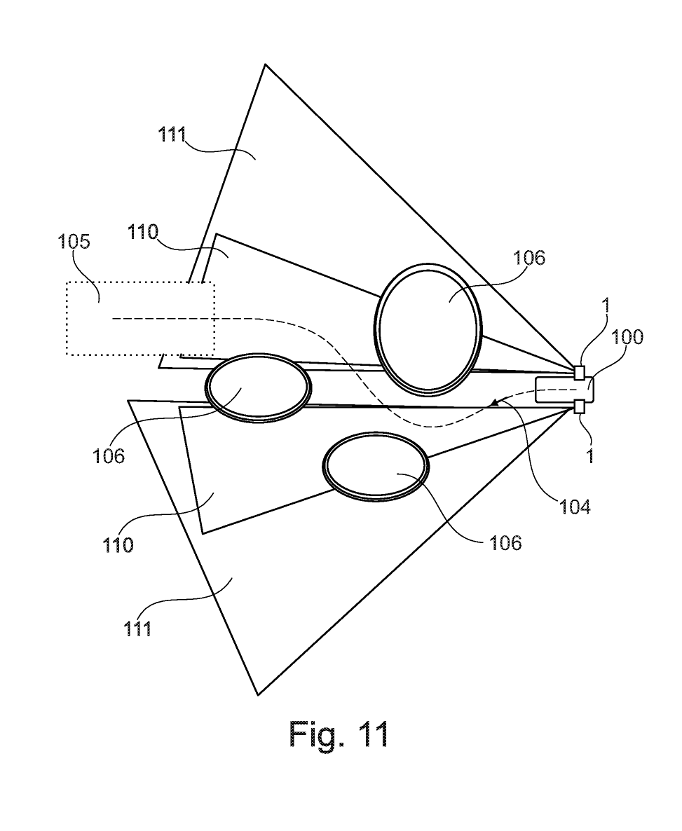

In FIG. 11, a further driving situation is schematically illustrated, in which a motor vehicle 100 equipped with two mirror devices 1 (right exterior mirror and left exterior mirror) is expediently used.

In the example according to FIG. 11, a driver of the motor vehicle 100 intends to move the motor vehicle 100 to a target position 105 along a curved driving path 104. Situated along the driving path 104 are a plurality of obstacles 106 around which the driver of the motor vehicle 100 has to maneuver the motor vehicle 100.

The mirror devices 1 provide the field of view 110 in their starting position. It is clear that some of the obstacles 106 are not sufficiently captured by the field of view 110.

By manipulating the mirror devices 1 such that the field of view 110 expands in a rearward region of the vehicle 100, it is possible to provide fields of view 111 which enable obstacles 106 to be monitored more completely. The driver of the motor vehicle 100 can therefore steer it along the desired driving path 104 more easily.

What is claimed:

1. A mirror device for a vehicle, comprising:
at least one planar mirror arrangement constructed as a mirror element and resiliently bendable at least about axes parallel or tangential to a mirror element surface or reversibly foldable about at least one fold line in the mirror element surface, wherein
the mirror element is coupled to at least one actuator, said at least one actuator being designed and constructed to effect a resilient bending or a reversible folding of the mirror element upon actuation.

2. The mirror device as claimed in claim 1, wherein the mirror element has a resiliently bendable support.

3. The mirror device as claimed in claim 2, wherein said resiliently bendable support is made from a material selected from a group consisting of a plastic, a glass or a metal.

4. The mirror device as claimed in claim 2, wherein the at least one actuator is constructed as an actuator matrix comprising a multiplicity of actuators, wherein individual actuators or actuator groups are independently actuated.

5. The mirror device as claimed in claim 4, wherein, to alter a field of view, the mirror element is resiliently deformable or reversibly foldable by means of the at least one actuator.

6. The mirror device as claimed in claim 5, wherein a sub-region of the mirror element is displaceable in a resiliently bendable or reversibly foldable manner relative to a residual region of the mirror element.

7. The mirror device as claimed in claim 6, wherein the mirror element is pivotable about at least one spatial axis and/or foldable along at least one spatial axis relative to a user such that the resiliently bendable or reversibly foldable mirror element is free of bending and folding deformations.

8. The mirror device as claimed in claim 7, wherein the resiliently bendable or reversibly foldable mirror element is deformable depending on a current driving/traffic situation.

9. The mirror device as claimed in claim 8, in which, to enable the reversible folding of the mirror element surface, the planar mirror arrangement has at least one first rigid mirror element and at least one second rigid mirror element, wherein the one first rigid mirror element and the one second rigid mirror element are displaceable such that they pivot with respect to one another about a pivot axis and at least one mirror element is coupled to at least one actuator which is designed and constructed to displace said at least one mirror element such that it pivots relative to the other mirror elements about the pivot axis.

10. The mirror device as claimed in claim 9, wherein the one first rigid mirror element and the one second rigid mirror element in a starting position collectively form a common kink-free mirror surface.

11. The mirror device as claimed in claim 9, wherein the one first rigid mirror element and the one second rigid mirror element are displaceable such that they pivot with respect to one another about a common outer edge.

12. The mirror device as claimed in claim 10, wherein the one first rigid mirror element and the one second rigid mirror element in the starting position abut against one another at edges without gaps and form an overall mirror surface which is kink free and/or has a constant curvature.

13. The mirror device as claimed in claim 9, wherein the mirror device is an exterior rearview mirror of a motor vehicle.

14. The mirror device as claimed in claim 1, in which, to enable the reversible folding of the mirror element surface, the planar mirror arrangement has at least one first rigid mirror element and at least one second rigid mirror element, wherein the one first rigid mirror element and the one second rigid mirror element are displaceable such that they pivot with respect to one another about a pivot axis and at least one mirror element is coupled to at least one actuator which is designed and constructed to displace said at least one mirror element such that it pivots relative to the other mirror elements about the pivot axis.

15. The mirror device as claimed in claim 14, wherein the one first rigid mirror element and the one second rigid mirror element in a starting position collectively form a common kink-free mirror surface.

16. The mirror device as claimed in claim 14, wherein the one first rigid mirror element and the one second rigid mirror element are displaceable such that they pivot with respect to one another about a common outer edge.

17. The mirror device as claimed in claim 15, wherein the one first rigid mirror element and the one second rigid mirror element in the starting position abut against one another at edges without gaps and form an overall mirror surface which is kink free and/or has a constant curvature.

18. The mirror device as claimed in claim 14, wherein the mirror device is an exterior rearview mirror of a motor vehicle.

19. The mirror device as claimed in claim 1, wherein the mirror element is pivotable about at least one spatial axis and/or foldable along at least one spatial axis relative to a user such that the mirror element is free of bending and folding deformations.

20. The mirror device as claimed in claim 19, wherein the mirror element is deformable depending on a current driving/traffic situation.
